(19) United States
(12) Patent Application Publication
(10) Pub. No.: US 2008/0153596 A1
(43) Pub. Date: Jun. 26, 2008

(54) System, method and apparatus for connecting video game players and associated virtual avatars to communicate, buy, sell, trade, search for companions, search for help, and exchange content about/of/in multiplayer online worlds

(76) Inventor: Long Ngoc Nguyen, Peoria, AZ (US)

Correspondence Address: Long Nguyen, 9736 W Black Hill Rd, Peoria, AZ, 85383, US

(21) Appl. No.: 11/614,973

(22) Filed: Dec. 21, 2006

(51) Int. Cl. G06F 19/00

(52) U.S. Cl. 463/42

(57) ABSTRACT

A website consisting of code to enable all gamers to input data for system to match players according to play time, guild, interest, and many other factor relating to Massive Multiplayer Online Game world. Prior Art such as forums, bulletin boards, shout channel inside a particular region within the game world only allow people to ask/shout for an adventure group only in that local region/time instant, the method is cumbersome and ineffective. The stated invention creates a method to automate the process of matching and allow players to search across multiple different virtual realms to locate garners who share similar play time and or interest to team up and adventure.

### TECHNICAL FIELD AND INDUSTRIAL APPLICABILITY OF THE INVENTION

This invention relates to online video games specifically to computer data and information systems accessed over the Internet, and more particularly to a computer-based system for more effectively connecting gamers.

### BACKGROUND OF THE INVENTION

In 1997, one of the first popular multiplayer massive online role playing game with complex detail and storyline, Ultima Online (http://www.uo.com/) was invented. This game allows thousand of players' world wide to connect to a evolving virtual world with its own economy system. These players gather into the virtual fantasy world to slay evil create, fight epic battles, meet friends online and have fun. At its peak, Ultima Online has over 500,000 registered players. Due to hardware restriction, one virtual world can only hold 3000 concurrent players logged in at one time so each world only has 10,000 to 15,000 players. In order to play, players create an avatar, a virtual fantasy character they would like to be in the world within the game's design limitation. Generally these massive multiplayer game allow players to become what they can not in real life, such as a sorcerer, an alchemist, a sword fighting master, and many other class that only exist in fantasy novel. While playing, character receive rewards such as in game currencies, magical items, powerful armor and weapons they can use for themselves, or sell to other players to get in game currencies to buy other things they need. In order to sell these things, player in Ultima Online have to purchase NPC (non player character, controlled by the game server) to sell items for them, or they would have to run around town shouting items they want to sell. This system is very ineffective as normally only a few % of players are at the area, the rest are out busy slaying demons and doing their own things or have important life matters to attend to such as work. Selling items in virtual game has always been a painful process much less getting the best amount for the items you are selling.

After the success of Ultima Online, many game started releasing virtual world of there own. Some of the most successful hits since Ultima Online are Everquest, Everquest II, Asheron's Call, Dark Age of Camelot, Final Fantasy XI, Line Age, Line Age II, World of Warcraft, and many others. Currently total gamers playing on these virtual worlds are over 15 million players world wide. For more information and history relating to multiplayer games, please visit: http://en.wikipedia.org/wiki/Massively_Multiplayer_Online_Role-Playing_Game

Some of these games require players to join a group of 5 to 7 player's to band together to fight enemy in order to advance farther in the game. Epic battles consist of gathering 24-40+ players together to fight powerful boss. For example, Final Fantasy XI, in order to advance in the game just to gain a level, player are forced to join group in order to advance. They have a built in search system in the game allowing players to go into “LFG” mode (Looking for Group) so that people can search and create group. The system is very in effective as it only allows players to search people currently online and playing. Many players normally end up waiting for hours and hours before getting an invite to join a group and normally have to leave soon after as their play time is limited. Almost if not all of Final Fantasy XI gamers have experience this problem.

Another problem these games have is players, requiring finding high level crafter to craft powerful sword, equipment, and other in game needs. However crafters are few and do not always play at the time everyone else is playing, players have a very hard time locating qualify crafter to do the work.

Players normally play a game for a few years, get bore with it and move into the next game. Game after game, they meet countless friends. Some close, some not so close, but over time they meet many gamers. All these wonderful memory are lost and they forget because there is no system in place to bridge these players together so they can keep the relationship going.

Across the internet, there are a lot of sites that create social networks to allow people to meet, communicate and exchange information. However all of these are focus on real world social interaction, none of them understand the needs of gamers. U.S. Pat. No. 7,069,308 clearly explain the background of social networkings and it's impact. These system work great for friends, family and real world acquaintance to stay connected and in contact. None of these take into account virtual world across many diff virtual universes.

Thus, the present invention allows players to stay connected from game to game, generation to generation. The invention also solves many online gaming problems such as allowing players to search for a specific need and or list things they need. Such as if a player want to look for a group between 5 pm to 10 pm, he can list that and other players around the world, without even connected to the game, can search the requirement, talk with the person and can arrange to play together. They can also post items they want to buy, want to sell, want to trade, services they are providing, and gamers across the world can easily locate the things they need easily thru the invention.

### BRIEF DESCRIPTION OF THE INVENTION

The invention provides a system for connecting players via an online database allowing players of all games, server, and virtual universe to gather together to find companions, locate friends from past games, find players that fit there gaming style and more importantly play schedule, search for items they want to buy sell or trade, list service and helpful information for other players, management tool for guild to help manage members, and keeping track of all players past gaming information so players can easily locate each other no matter what game they move onto.

### DETAIL DESCRIPTION OF THE INVENTION

In the interest of clarity, not all features of the implementations described herein are shown and described. In the development of any actual implementation, a lot of decisions involving the implementation-specific must be made to achieve the developer's specific goals while keeping compliance with application and business relayed constraints. Due the nature of the inventions, specific goals will vary from one implementation to another and from developer to developer.

To implement the invention, first thing we need to do is plan out the database. A thoroughly planned database will allow the invention to virtually do anything and implementation will be smooth. While planning the database, keep in mind the goals and what each section of the goals does.

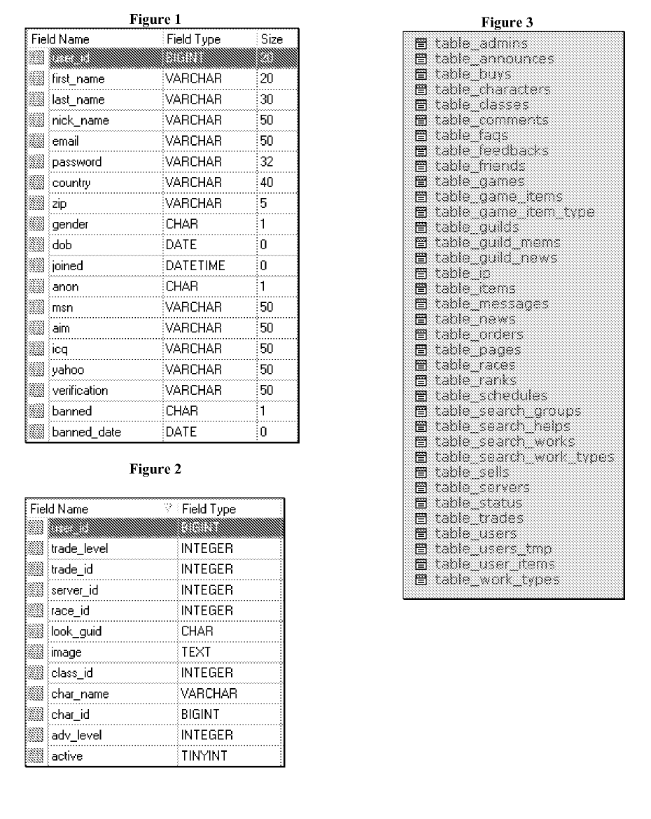

First, we will start with users. When users connect to our invention, we will need a method to keep track of who is the person that is logging in. The table users in the database should contain detail of the users and a special id so we can uniquely identify who the user is. An example for table users would be best described in FIG. 1 of the drawings.

We then have a table for users to hold characters. Each user can have a lot of character on each game. So when they login, they can go to the control panel, see a listing of all the character they have, then add character. With this in our database, we can easily connect all there friends together and allow people to easier find friends/people whom they have meant while playing easily. FIG. 2 is an example of what should be included in the character table. Now we can use user_id to link with table users to show a certain character belong to what user. Keep in mind when designing the character table, to include all field that correctly describe a character in all game. For example, all game would have character name, what game/server that character is on, what type of character is that person, what race is the person, allow image attachment, what level, and so forth.

Now we have a table to hold all type of items in game. The table would normally consist of an item_id, what game it exist on, item name, what type of item it is, what special attribute it has, what make it special, description of the item, and information relevant to finding the item in the game. With this table, we can then link up with another table, where users can select if they are looking to buy one of those items, sell one of those items, or trade. We can also link these items directly to each character to show what item each character is wearing trying to make the character as close to resemblance of there in-game character as possible. This table item can be very useful to linking many things including guild function, auction, questing service, and so forth.

Now that we lay out the ground work for want to buy, sell, trade and general item listing, we can move onto guild management stuff. This part is pretty big, in the interest of clarity and keeping thing simple, not all feature are explained in deep detail as it pertain to how much implementation time and what each implementation project goal is. Each character can create a guild, or join a guild. Then from the guild, we would have event calendar for the guild to keep track of weekly events for the guild, we will also keep track of DKP and dkp history per member. Dragon Kill Points is a system designed to facilitate fair distribution of items and have become acceptable to the general gaming community as the best way to distribute guild items. More information about DKP can be found via website at: http://en.wikipedia.org/wiki/DKP_(Point_System)

Next step is implementing the play schedule of each character. The table should allow users to any date/time combo. One problem you might run into is when a character plays from 21:00 hour to the next day 3:00. We had a lot of difficulty implementing it. The best method to fix this is to break it into 2 entries. One entry would be from 21:00->24:59 and the second entry would be 0:00->3:00 and insert it into database like that. Keep in mind when queries area made to pull from database to treat it as consecutive play time.

You will also need a table to store submitted entries such as news related to the game, the specific server, data such as items, quests, events hosting, each with it's own required attribute depending on your project goal.

When designing the database, also remember you will need to create a table to store list of games, servers, items, quests so you can easily pull the data from these table as everything is related to one another.

In the interest of keeping this document simple and not long-winded, FIG. 3 is a sample list of most of the table in the database for those skilled in the arts will be able to understand and easily implement. Keep in mind, certain goal and implementation specific may require more tables depending on the goal or the way the programmer would like to control the data. The list is provided as a stepping stone and ground work to help ones skilled in the art implement such a large project. It is in no way a reflection of the limitation of the apparatus.

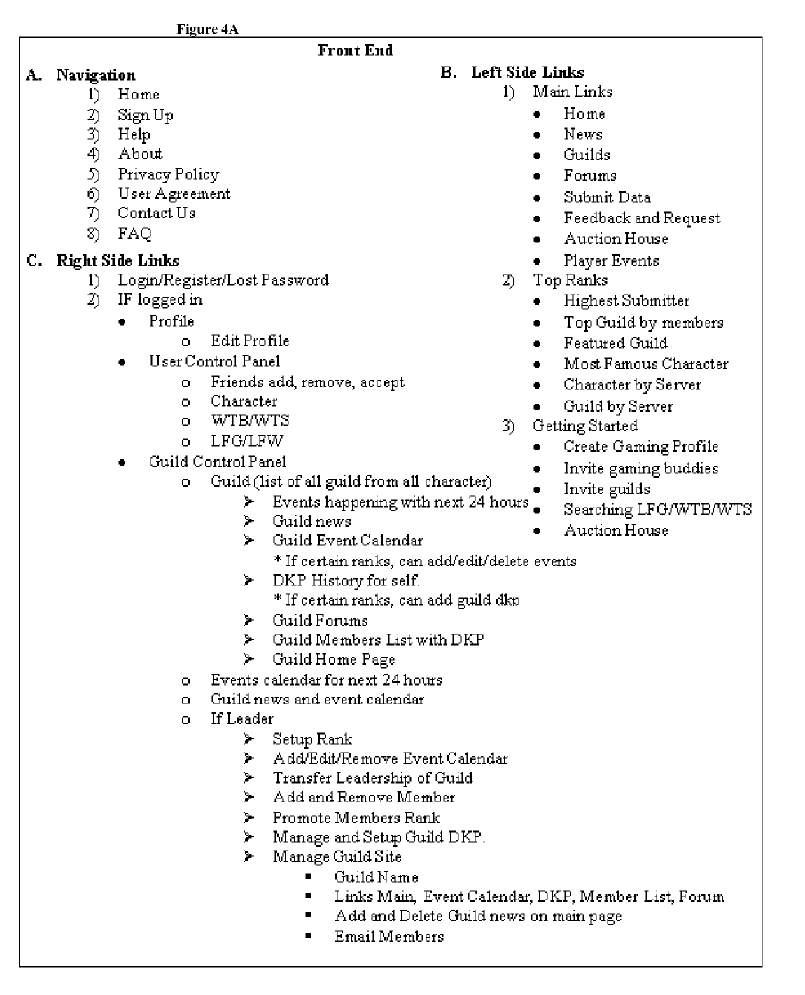

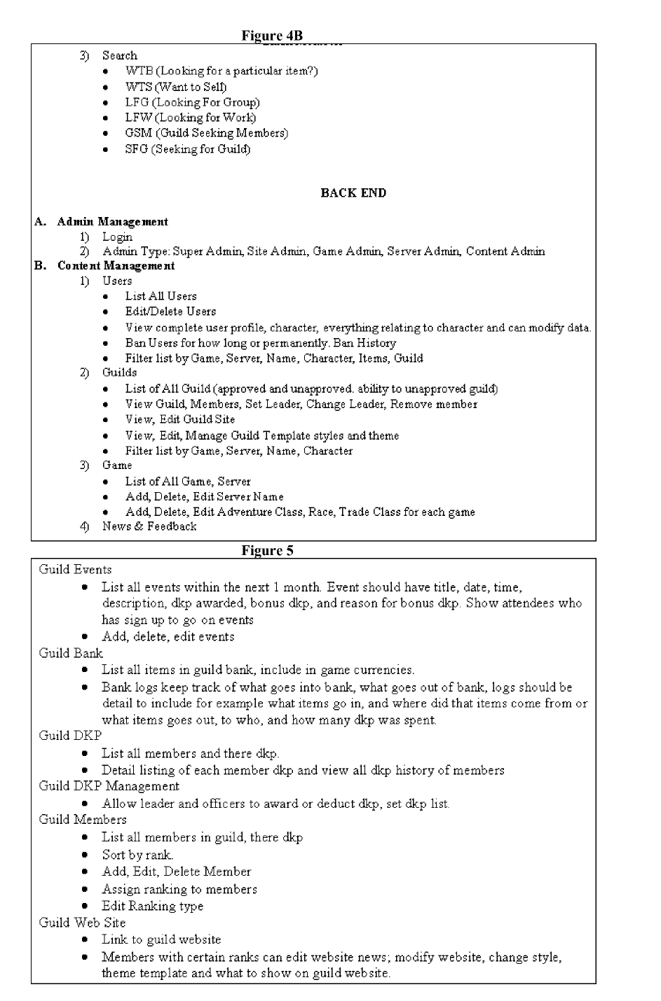

Now that you have most of the database iron out, we move onto the design and coding stage. There is not much to discuss about design since it is purely taste on how the site look and feel. This will vary from implementation to implementation greatly as different designer have different way of designing professional website. To effectively code the site, it is recommended ones skilled in the art sit down, and make a task list, with goal, objective so that the work flow has time line and can flow. Of course this will be different from project to project, however make sure you include all the basis of the site. FIGS. 4A, 4B and 5 is a pseudo drawing of the task list/site layout. This task list/site layout is provided as a stepping stone and example for ones skill in the art to easily see what all is involved and help plan implementation better. It is by no mean consider complete or limitation of the apparatus.

Once the apparatus is in place, gamers from around the world can come to the site and register. From there they can create character from past games they have play, character currently play, and games they intend on playing. Other users' whom have played or is currently playing with that character can be friend with that character. Gamers all around the world can easily search for companions whom they have play with and is currently playing and can communicate and keep track of each other very easily.

Each character would then be able to list time schedule, items they want to buy, sell, trade and even services they can provide to the communities. Players A, who need a certain item, can just search the website to see if thousands of other players have those particular items for sale. This is a large leap in the current game limitation. Currently, games only allow you to post items on auction within the video games and you can go there and bid. What if the item is not for sale? People have it, don't intend to sell it but would sell it if the price is right? Without this, there is no way of even knowing who has it and might consider selling those items. You can now with this apparatus be able to put items you would like to buy. Currently, there is no game out there that allow for this feature. One game server has thousands and thousands of players. Without this apparatus, there is no way to know who wants to buy a certain items accept via friends and shouting in game, which is very slow and ineffective. The in game method of selling the item also has a flaw in that you have to be in game to sell or post it. So people looking to buy something have to be in game to find the items to buy. The apparatus will allow people to find things they want without being connected to the games. For example, Player A is looking to buy a rare item call Armor of Protection. While at work, he has 15 min breaks, he can easily visit the apparatus, search for the items, see a few people selling it, and instantly message the person with it for sell requesting to purchase, price, or an agreement of some sort between the two users.

The major feature this apparatus provide is it allow gamers across the world to organize and play together easier and to find help. Current, a lot of games such as Final Fantasy XI, Everquest, Everquest 2, Dark Age of Camelot, and most other online games require a group of players' band together to complete task, or even just to simply advance game. Final Fantasy XI is a prime example of requiring group to advance farther in the game. Many games spend 2-5+ hours each day just Looking for group in game. There is no way for them to do it other wise accept maybe post on forum board with only game fanatics visit and often because it is a bulletin board, very ineffective. The apparatus will allow players to input there play schedule and search other players play schedule playing on the same game/server. Then those players can communicate with each other to see if they would like to play with each other. This will allow finding gaming companionship extremely easy. Another impressive thing is they can do this without even being in the game itself. Just input the data on the website and at there convenience can look for people, or other can look for them anywhere in the world with out even requiring them to be at home playing which mean while at work, during break time, school break time, they can arrange a full team so when they get home, they just login, gather together and start adventuring together! The other feature is finding help. Currently, if a player need help to do a certain quest or beat a certain boss, they need to find there friends, guild members, or just shout in the middle of town, which normally only have 50 people around and hope someone is nice enough to help. Now, they can just search for people willing to help for a price or for fun. They can also search for people doing similar quest or needing to kill similar enemy and help each other out prior to going home. Now players across the world can login and begin adventuring and have fun without the problem that current multiplayer games have. No longer will they wait hours in game to find a group or help.

The invention creates a number of advantages. Interaction between players increased greatly with the system and allows them to track each other from game to game. Finding companions, finding help, buying items, selling items and managing guide use to be impossible now can easily be done regardless if the player is in the game, at work, or anywhere with an internet connection. Thus, with the inventions, gamers can reduce many time-consuming ineffective methods and make use of their free time while at work, school, and small breaks more useful allowing them to enjoy the game they play more.

Although the invention has been described with reference to a particular implementation, it is to be understood that it is merely illustrative of the principles and application of the present invention. It is therefore to be understood that numerous modifications and arrangements may be devised without departing from the spirit of the present invention as defined by the appended claims.

What is claimed is:

1. A system including server and database of users which have unique user id, whom can create profile in the database to include characters, inventory, play schedule, items selling, items buying, items trading, services offering, friends, guilds, and event hosting.

2. A method according to claim 1, wherein users create characters to have information just like what they have in the game, creating online profile so that other players can view character information anywhere anytime without requiring players to be in the game and or on the same game server.

3. A method according to claim 1, wherein users create character inventories to have information just like what they have in the game, creating an online inventory system so they can easily view what they have anywhere anytime.

4. A method according to claim 1, wherein users create play schedule.

5. A method according to claim 1, wherein users create a list of items they want to sell, items they are looking for, services they are looking for and services they are offering.

6. A method according to claim 1, wherein users create a list of friends they have played with or cross path throughout there gaming time.

7. A method according to claim 6, wherein allowing users to communicate with gamers whom they have cross path throughout there gaming career.

8. A method according to claim 1, wherein users create, join, and manage guilds.

9. A method according to claim 8, wherein users manage and distribute DKP to members in guild.

10. A method according to claim 1, wherein users and guilds create, manage and host events.

11. A method according to claim 1, 2, 3, 4, 5, 6, 7, 8, 9, and 10, wherein users can search and view all above claims.
